(19) United States
(12) Patent Application Publication
(10) Pub. No.: US 2002/0087313 A1
(43) Pub. Date: Jul. 4, 2002

(54) Computer-implemented intelligent speech model partitioning method and system

(76) Inventors: Victor Wai Leung Lee, Waterloo (CA); Otman A. Basir, Kitchener (CA); Fakhreddine O. Karray, Waterloo (CA); Jiping Sun, Waterloo (CA); Xing Jing, Waterloo (CA)

Correspondence Address: Jones, Day, Reavis and Pogue, North Point, 901 Lakeside Avenue, Cleveland, OH, 44114, US

(21) Appl. No.: 09/863,937

(22) Filed: May 23, 2001

Related U.S. Application Data
(60) Provisional application No. 60/258,911, filed on Dec. 29, 2000.

(51) Int. Cl. G10L 15/04

(52) U.S. Cl. 704/254

(57) ABSTRACT

A computer-implemented method and system for generating speech models for use in speech recognition of a user speech input. Word conceptual networks are formed by grouping words with pre-selected pivot words. The groupings of words form phrases directed to pre-selected concepts. Phoneme networks are associated with the words in the word conceptual networks. The phoneme networks contain probabilities for recognizing the words in the word conceptual networks. A language model is partitioned into sub-language models based upon the pivot words. The sub-language models include the phoneme networks that are associated with the words grouped with the sub-language models' respective pivot words.

### RELATED APPLICATION

This application claims priority to U.S. Provisional Application Serial No. 60/258,911 entitled “Voice Portal Management System and Method” filed Dec. 29, 2000. By this reference, the full disclosure, including the drawings, of U.S. Provisional Application Serial No. 60/258,911 is incorporated herein.

### FIELD OF THE INVENTION

The present invention relates generally to computer speech processing systems and more particularly, to computer systems that recognize speech.

### BACKGROUND AND SUMMARY OF THE INVENTION

Previous speech recognition systems have been limited in the size of the word dictionary that may be used to recognize a user's speech. This has limited the scope of such speech recognition systems to handle a variety of user's spoken requests. The present invention overcomes this and other disadvantages of the previous systems. In accordance with the teachings of the present invention, a computer-implemented method and system are provided for generating speech models for use in speech recognition of a user speech input. Word conceptual networks are formed by grouping words with pre-selected pivot words. The groupings of words form phrases directed to pre-selected concepts. Phoneme networks are associated with the words in the word conceptual networks. The phoneme networks contain probabilities for recognizing the words in the word conceptual networks. A language model is partitioned into sub-language models based upon the pivot words. The sub-language models include the phoneme networks that are associated with the words grouped with the sub-language models' respective pivot words.

Further areas of applicability of the present invention will become apparent from the detailed description provided hereinafter. It should be understood however that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIG. 1 is a system block diagram depicting the software-implemented components used by the present invention for speech recognition;

FIG. 2 is a block diagram depicting the construction of word and phoneme networks and clusters;

FIG. 3 is a diagram depicting word networks branching from a pivot word;

FIG. 4 is a sequence diagram depicting an exemplary word network of the present invention;

FIG. 5 is a probability propagation diagram depicting semantic relationships constructed through serial and parallel linking;

FIG. 6 is a block diagram depicting the present invention processing an exemplary user request;

FIG. 7 is a block diagram depicting the web summary knowledge database for use in speech recognition;

FIG. 8 is a block diagram depicting the conceptual knowledge database unit for use in speech recognition; and

FIG. 9 is a block diagram depicting the phonetic knowledge unit for use in speech recognition.

### DETAILED DESCRIPTION OF A PREFERRED EMBODIMENT

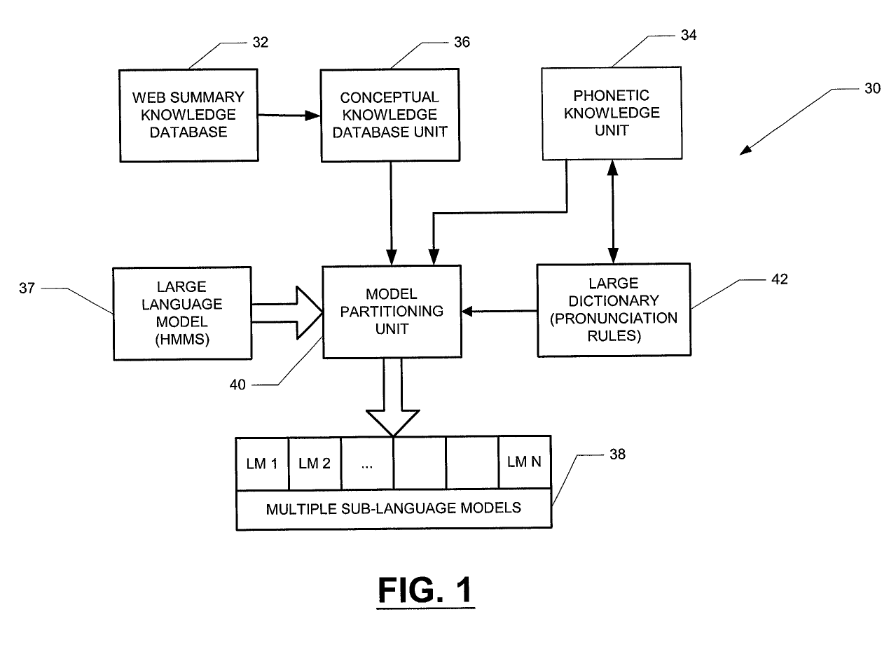

FIG. 1 depicts an intelligent speech model partitioning system 30 of the present invention. With reference to FIG. 1, the intelligent speech model partitioning system 30 uses word usage data, semantic data, and phonetic data to partition a “large” language model 37 into smaller sub-language models 38. The speech recognition process uses the partitioned sublanguage models 38 to recognize user speech input. The smaller sub-language models 38 can allow the overall speech recognition process to proceed quickly and efficiently.

A large language model 37 is initially partitioned into the smaller language modes 38 based upon semantic data. The semantic data is used to establish what concepts are interrelated. For example, the term “weather” and “city” have a relatively high degree of interrelatedness, signifying that the speech recognition process has a higher degree of recognition confidence if both “weather” and “city” were recognized. In contrast, the speech recognition would have a lower degree of recognition confidence if both “weather” and “pepper” were recognized due to those terms' low interrelatedness.

A conceptual knowledge database unit 36 stores concept interrelatedness data and concept structure data. This concept data is derived from word usage on Internet web pages.

Summaries of Internet web pages are stored in a web summary knowledge database 32. The web page summary information is examined to determine which concepts most regularly appear together. The determination produces the concept interrelatedness data that is stored in the conceptual knowledge database unit 36. Concept structure data stored in the conceptual knowledge database unit 36 also contains hierarchies of concepts. Such a hierarchy of concepts may be a hierarchy of countries, states, and cities. For example, the United States contains states (such as Illinois) which contain cities (such as Chicago).

Using the concept interrelatedness data and concept structure data to partition the large language model 37, a model partitioning unit 40 designates words as belonging to one of the sub-language models 38. The designation is sometimes referred to as “chunking.” More specifically, the concept structure data allows multiple sub-language models 38 to be built at different conceptual hierarchies. The concept interrelatedness data allows multiple sub-language models 38 to hold words that may be found in different hierarchies. For example, one of the sublanguage models 38 may include the words weather and city because of their relatively high degree of interrelatedness despite being in two different conceptual hierarchies.

The language model 37 may be any type of speech recognition language model, such as a Hidden Markov Model. The Hidden Markov Model technique is described generally in such references as “Robustness In Automatic Speech Recognition”, Jean Claude Junqua et al., Kluwer Academic Publishers, Norwell, Mass., 1996, pages 90-102.

The model partitioning unit 40 examines a “large” dictionary 42. The dictionary 42 contains pronunciation rules that map a spelled word to a series of phonemes that indicate how the spelled word is pronounced. The dictionary 42 groups the phonemes in several ways. The phonemes are grouped in series that form verbal words, as described above. These verbal words correspond to text words. The dictionary 42 can then associate the phoneme series with text words.

Another way that the dictionary 42 can group phonemes is by the similarity of phonemes to each other. Similar sounding phonemes are grouped into phoneme clusters. Still another way that the dictionary 42 can group series of phonemes where the phonemes in the series are similar to the phonemes in other series. Similar sounding phoneme series are grouped into network clusters. Because phoneme series represent words, series of similar sounding phonemes can represent similar sounding words. That is, words that may be mistaken for each other by a voice recognition system.

The phonetic knowledge unit 34 analyzes the dictionary 42 to determine the phonetic similarity of words. Phonetically similar data is provided by the phonetic knowledge unit 34 to the model partitioning unit 40. The phonetic similarity data is based on statistical data that is gained from speech signals. Trained statistical phoneme models (e.g., continuous density Gaussian HMMs) map speech signals to phonemes. The phonetic knowledge unit 34 understands basic units of sound for the pronunciation of words and sound to letter conversion rules in order to generate the phoneme clusters. It relays this understanding to the model partitioning unit 40.

As the user utterance is scanned, a series of phonemes representing a word is recognized. A subset of words with similar pronunciation, that is, similar phoneme cluster or similar phoneme networks, is determined by the phonetic knowledge unit 34. To ensure correct recognition, the subset is delivered to the model partitioning unit 40. Using the phoneme clusters and phoneme networks, the model partitioning unit 40 includes words that have similar pronunciations in the sub-language models 38.

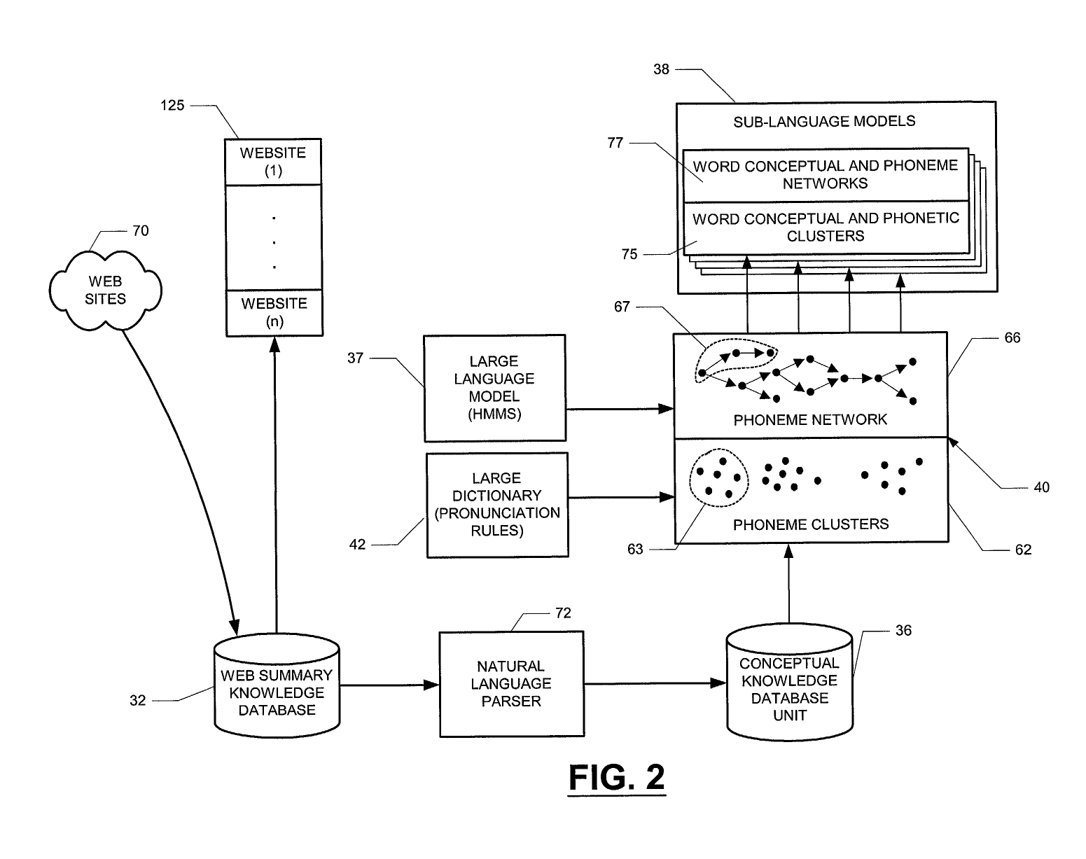

FIG. 2 depicts the creation of sub language models by the model partitioning unit 40. There are two partitioning phases performed by the model partitioning unit 40. In a first partitioning phase, the phoneme sequences of the large dictionary 42 are partitioned into the smallest possible groups of phoneme clusters 62. The phoneme clusters 62, which can be of varying types, are mapped onto a phonetic space. For example, phoneme cluster 63 is a cluster of phonemes that sound similarly. Other clusters can include a cluster of bi-phones of similar pronunciations or a cluster of tri-phones of similar pronunciations. The nodes of the clusters may represent different types of phonemes. The pronunciation rules of the large dictionary 42 provides a source of information for forming phoneme clusters of different types. The metric distance between phonemes in the phoneme space represents the pronunciation distinction among similar sounding phonemes. The closer the nodes, the more similar the sound.

In a second partitioning phase, the large language model 37 is partitioned into a plurality of sub-language models 38 by the model partitioning unit 40. These sub language models 38 are in the form of phoneme networks 66. Phoneme networks 66 are, in a preferred embodiment, HMMs whose links between the phoneme nodes include a weight. The weights can be used to represent the frequency in which important phonemes occur with respect to a concept. Phonemes may exist as individual nodes or as phoneme clusters 62. For example, the first node, representing a phoneme in the phoneme network 67, may map to a second node, representing a phoneme, in phoneme cluster 63.

In a different example, the phoneme cluster 63 may represent bi-phones. Biphones are phonemes that sound similar to each other. In this instance, the first two phonemes in the phoneme network 67 may map to a single node in phoneme cluster 63.

The position of each phoneme, including the metric distances among the phonemes, is laid out in such a manner that a network among the different phonemes can be formed. The web summary knowledge database 32 is used to determine what weights are assigned to the phoneme links in the phoneme network layer 66. The web summary knowledge database 32 gathers web sites 70 of a defined domain (such as weather), and determines which are the most frequently used grammatical sub units (e.g., nouns, verbs and adjectives) on the web sites and what their relationships. Also, the web sites' topologies (such as to what other web pages are they linked) are determined and stored as web site index 125 in the web summary knowledge database 32.

More specifically for the phoneme network 66, the vector representation is the direction from which one phoneme transitions to the next to form a given word. A depth parameter indicates the number of phonemes in a chain sequence before a word is completely represented. A phonetic network parameter is the number of times a link occurs between two phonemes. This information and these vectors are then used to map a network onto a phoneme cluster 62.

Phoneme vectors may be directed within each small cluster, forming inter-phoneme networks. An extra-phoneme network is formed when vectors bridge across phonetic clusters. Together, the inter- and extra-phoneme networks define a phoneme network 66. The phoneme network 66, formed by these two types of phoneme networks, is used to form the next level of partitioning. The original groups of phoneme clusters 62 are further combined into a smaller number of larger clusters. Phonemes that are connected by the network 66 are gathered into the new clustering. Several parameters and setups are used to determine how the new partitioning is formed: the number of phonemes in the original clustering, the depth parameter, the frequency for each network to occur, as well as the phonemes being shared among phoneme vectors.

The next phase of the model partitioning is a syntactic determination process which is accomplished by a natural language parser 72. The natural language parser 72 generates a syntactic representation of each sentence (i.e., which words of the web page operates as a noun, verb, adjective, etc.) contained in the web summary knowledge database 32. The natural language parser 72 is described in co-applicants' co-pending U.S. patent application Ser. No. 09/732,190 (entitled “Natural English Language Search and Retrieval System and Method”) filed on Dec. 12, 2000, which is hereby incorporated by reference (including any and all drawings).

Pivot words from each syntactic representation are gathered. Each of the words is further mapped to a phoneme sequence vector representation in the phoneme network 66. The sub-language models 38 can then partitioned into their final form. The partitioning can be accomplished by applying Hidden Markov Model (HMM) principles in conceptual and semantic space.

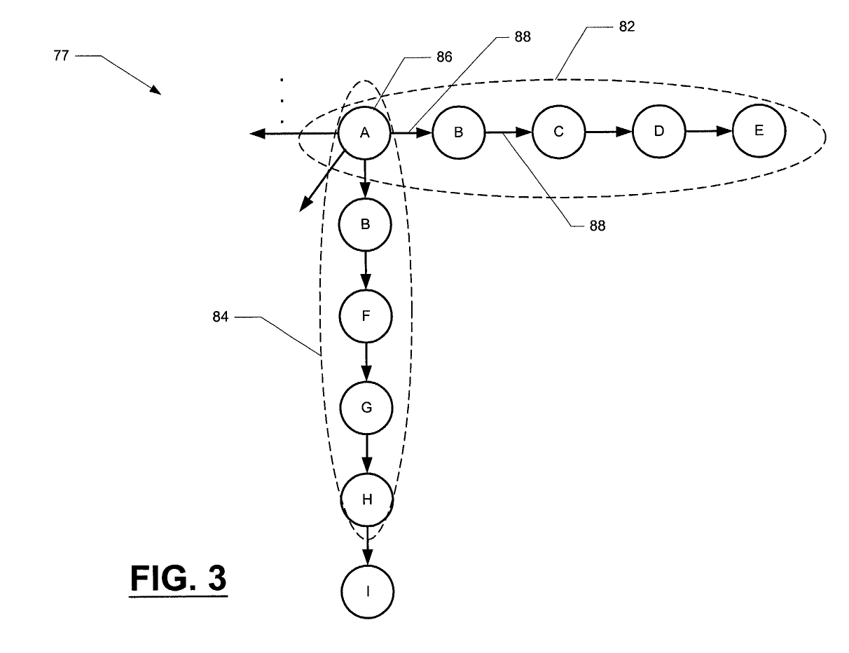

The web summary knowledge database 32 uses the natural language parsing technology to determine semantic relationships among different words in a set of chosen web sites 70 to create the multiple sub-language models 38. These words are used to create word conceptual and phoneme clusters 75 and a word conceptual and phonetic network 77. The clusters 75 are an aggregation of words that relate to a similar concept. For example, the words “email”, “telephone”, and “fax” are in the same word conceptual cluster entitled “contact” because these are different methods of contacting another person. The resulting sub-language models 38 include the word conceptual networks as they are associated with phoneme networks, shown at reference numeral 77, and with word conceptual clusters as they are associated with phoneme clusters, shown at reference numeral 75. FIG. 3 depicts interrelationships among networks and clusters.

FIG. 3 depicts exemplary word conceptual networks 77. Two word conceptual networks 82 and 84 are shown, both with their initial word node being a node representing word “A” 86. Node 86 defines a pivot word from which to create word conceptual networks. The designation of node 86 as a pivot word hinges on node 86 having a number of branches above a predetermined threshold number of branches, such as ten. Each node in the word conceptual networks 82 and 84 is an individual word. For example, word conceptual network 82 may represent the phrase: “call John on cell phone” (where “call” corresponds to word A, “John” corresponds to word B, “on” corresponds to word C, “cell” corresponds to word D, and “phone” corresponds to word E). Word “I” represents a word in the same phonetic series as the words in the conceptual network 84, but is not defined as being a part of the conceptual network 84. Word conceptual network 84 may contain a variation of network 82. Word conceptual network 84 may, for example, corresponding to the phrase: “call John through fax machine.” Each word of the phase corresponds to a node in the network 84. Note that the phrases overlap with the word “call” and the networks overlap with the node A representing the word “call.” The size of a network may be predetermined. That is, each network may be predetermined to look at no more than four words about a pivot word. It should be understood that the predetermined sizes for determining the pivot word and network about the pivot word may vary to suit the application at hand.

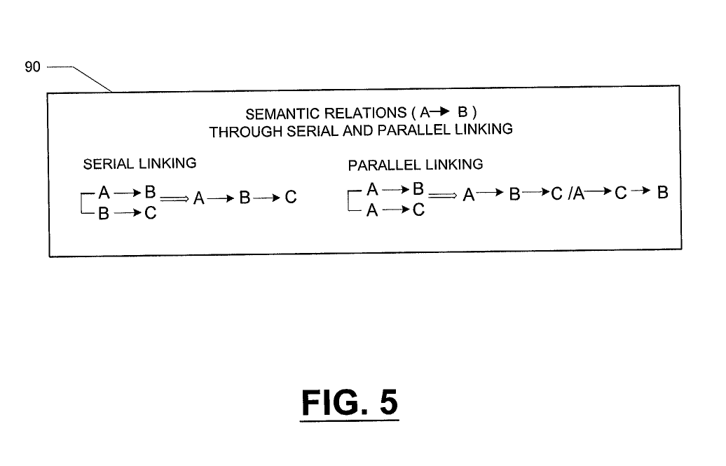

The word conceptual network 77 includes word vectors 88, similar to the phoneme vectors of the phoneme network layer. The word vectors 88 contain directions from one word to another, in order to create semantic and meaning representations of various concept. The word vectors 88 are further applied to the phoneme network partitioning, forming further relationships among words in these clusters. Semantic representations are generated by vectors formed among phoneme networks 66 in each cluster. Concept context switching may be accomplished by following directional vectors formed among clusters, which further represent the conceptual direction of words. The result defines the connection network that joins these phonemes into a series that represents a word. The result also defines a conceptual layer, which in turn defines the clustering and sequences of words. The word conceptual networks 77 may examine a group of words and apply serial linking and parallel linking rules to form a more sophisticated network of word concepts, as described in greater detail with reference to FIG. 5.

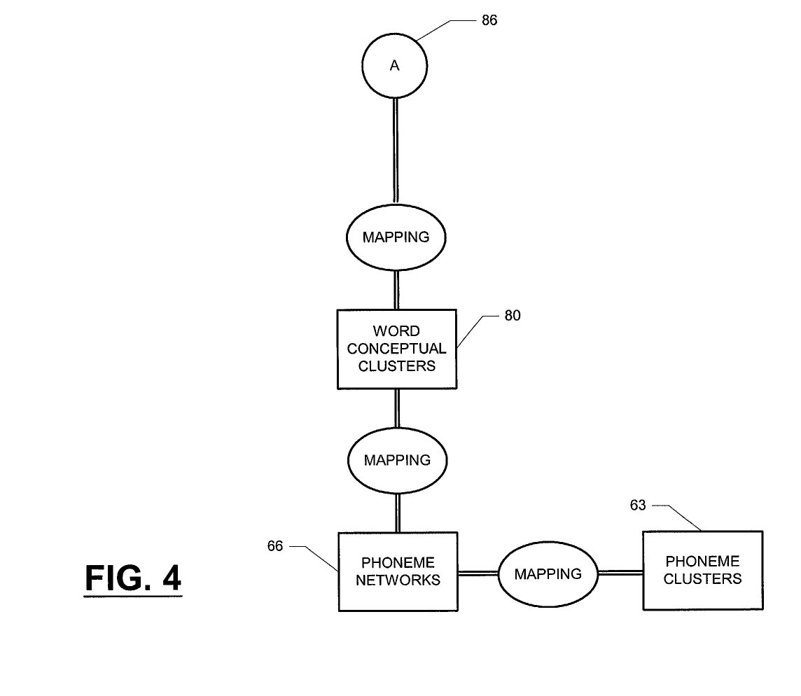

FIG. 4 depicts the direct and indirect mappings of a word to word clusters 80, phoneme networks 66, and phoneme clusters 63. Specifically, word “A” 86 is mapped to one or more word conceptual clusters 80. This is indicated by the double line. For example, “call” (word A) may be mapped to a word conceptual cluster containing an aggregation of different nodes representing different ways of contacting a person. Each of the words in the word conceptual cluster 80 is respectively mapped to a corresponding phoneme network among the phoneme networks 66. The phoneme networks 66 include HMMs on how the words may be pronounced. Weights in the phoneme networks 66 indicate the frequency of use of a particular phoneme transition. The nodes in the phoneme networks 66 are mapped to one or phoneme clusters 63. The network to cluster mapping indicates which other phonemes sound similarly. In this way, the phonetic variance of the nodes in the phoneme networks 66 is defined.

FIG. 5 shows an example of constructing word conceptual networks by serial linking and by parallel linking. Box 90 depicts the word network propagation mechanism. By this mechanism, two word conceptual relations are linked either in serial or in parallel in order to generate long sequences of words relating to a concept. In a serial linking example, word “A” and word “B” are linked, and word “B” and word “C” are linked. Serial linking combines the words to form a serial path from word “A” to word “B” and then to word “C”.

In a parallel linking example, words “A” and “B” are interrelated as well as words “A” and “C”. A parallel combination produces two paths of: word “A” to word “B” and then to word “C”; and word “A” to word “C” and then to word “B”. Through serial linking and parallel linking, sophisticated word networks may by created by the present invention. Serial linking and parallel linking is based on statistical grammar rules discussed generally in the following reference: “Speech and Language Processing: An Introduction to Natural Language Processing, Computational Linguistics and Speech Recognition”, James Martin, Daniel Jurafsky, Prentice Hall, 2000.

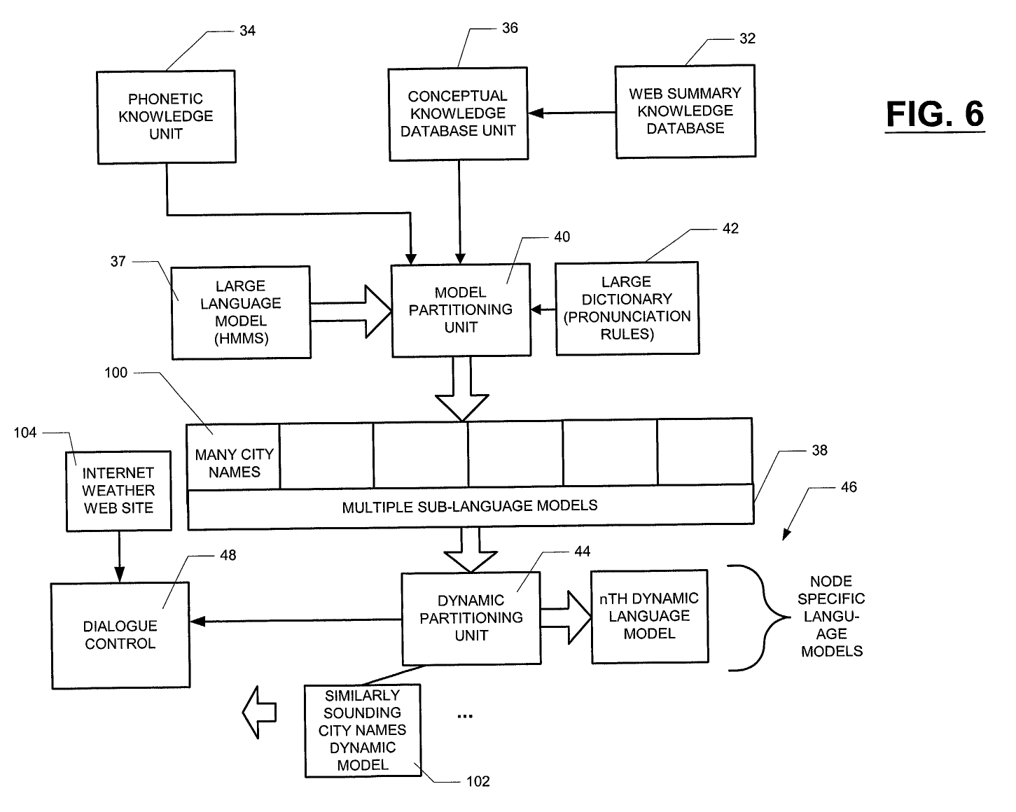

An example of the present invention being used with a dynamic partitioning unit 44 is depicted in FIG. 6. In an embodiment of the present invention, the model partitioning unit 40 creates sub-language models 38 for use by a dynamic partitioning unit 44. The dynamic partitioning unit 44 can create new sub language models on-the-fly based upon user input, as indicated generally by reference numeral 46. For example, if a user requests information on the weather in Tahoma, the model partitioning unit 40, using the phonetic knowledge unit 34, and the web summary knowledge database 32 via the conceptual knowledge database unit 36, determines that a weather report for a city was requested. A sub-language model for city names is scanned by the model partitioning unit 40 to generate the city names multiple language model 100.

The phoneme clustering in the model partitioning unit 40 enables the selection of phoneme networks with a pronunciation that is similar to the pronunciation of Tahoma. These phoneme networks are aggregated by the model partitioning unit 40 into a sub-language model 38. Specifically, the sub-language city names model 100 is formed. The city names model 100 is populated with a large assortment of city names from the large language model 37 and large dictionary 42 by the model partitioning unit 40.

The word conceptual network in the sub language model 100 indicates that the word Tahoma represents a city name concept and is a noun that can possibly be joined by verbs and/or weather concepts. Subsets defining node specific language models (e.g., similar pronunciations) can be partitioned from the sub language model with the use of the phonetic network knowledge by the dynamic partitioning unit 44, as shown generally by reference numeral 46. Specifically, the dynamic partitioning unit 44 extracts similarly pronounced city names from the city names model 100 and groups them into a smaller dynamic model 102. For this example, Tahoma, Sonoma, and Pomona extracted and grouped together in the dynamic language model 102 due to their similar sounds and the phonetic vectors formed amongst them.

The dialogue control 48 calculates the phonetic depth, metric distances, and phonetic frequency between the phonetic networks phonemes in the city names. Specifically using the above example, the dialogue control 48 is supplied with a city name dynamic model 102. Using the dynamic model 102 provided by the dynamic partitioning unit 44, the dialog control 48 identifies the cities provided, these could include, for example, Tahoma, Sonoma, and Pomona. The dialog control 48 then calculates and verifies that, of the list of cities provided in the dynamic model 102, Tahoma is the correct city. The dialog control 48 then scans the weather web site 104 for a weather report satisfying the user request. Using the funneled system of the present invention the dialog control need not choose from all of the possibilities that could represent the concept of the user request. Instead, it need only determine the correct concept from a smaller list of possible choices representing more likely conceptual matches to the user request concept. In this manner, efficiency and accuracy may be increased.

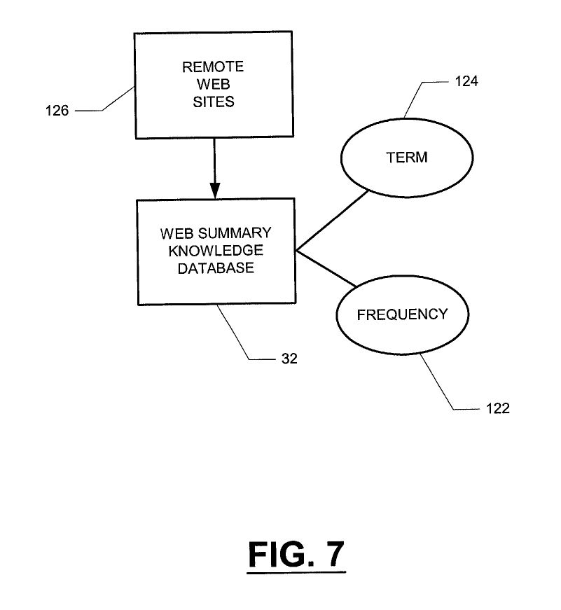

FIG. 7 depicts an exemplary structure of the web summary knowledge database 32. The web summary information database 32 contains terms and summaries derived from relevant web sites 126. The summaries include information such as the frequency of a term appearing on a webpage. The web summary knowledge database 32 contains information that has been reorganized from the web sites 126 so as to store, among other things, the topology of the web sites 126. Using structure and relative link information, the database 32 filters irrelevant and undesirable information including figures, ads, graphics, Flash and Java scripts. The remaining content of each page is categorized, classified and itemized. For example, the web summary database may contain a summary of the Amazon.com web site and determines the frequency that the term “golf” appeared on the web site.

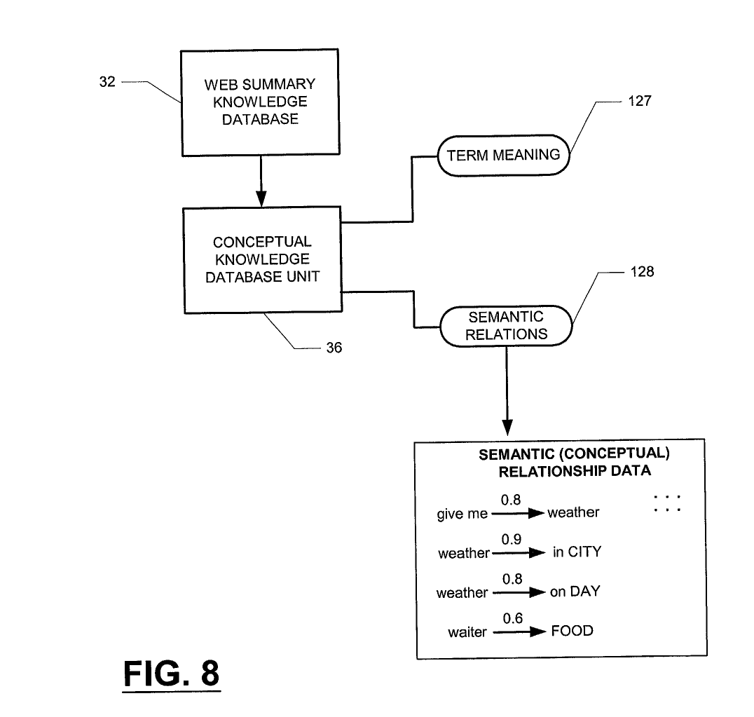

FIG. 8 depicts an exemplary structure of the conceptual knowledge database unit 36. The conceptual knowledge database unit 36 encompasses the comprehension of word concept structure and relations. The conceptual knowledge database unit understands the meanings 127 of terms in the corpora and the semantic relationships 128 between terms/words.

The conceptual knowledge database unit 36 provides a knowledge base of semantic relationships among words, thus providing a framework for understanding natural language. For example, the conceptual knowledge database unit may contain an association (i.e., a mapping) between the concept “weather” and the concept “city”. These associations are formed by scanning the web summary knowledge database 32, to obtain conceptual relationships between words and categories, and by their contextual relationship within sentences.

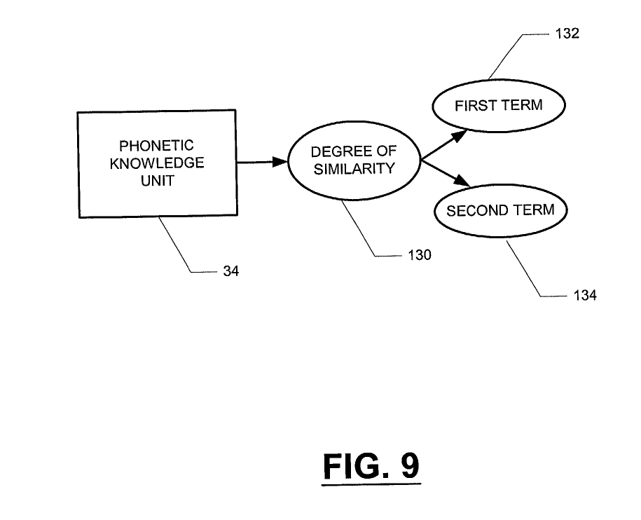

FIG. 9 depicts an exemplary structure of the phonetic knowledge unit 34. The phonetic knowledge unit 34 defines the degree of similarity 130 between pronunciations for distinct terms 132 and 134. The phonetic knowledge unit 34 understands the basic units of sound for the pronunciation of words (i.e., phonemes) and the sound to letter conversion rules. If, for example, a user requested information on the weather in Tahoma, the phonetic knowledge unit 34 is used to generate a subset of names with similar pronunciation to Tahoma. Thus, Tahoma, Sonoma, and Pomona may be grouped together in a node specific language model for terms with similar sounds. The present invention analyzes the group with other speech recognition techniques to determine the most likely correct word.

The preferred embodiment described within this document with reference to the drawing figure(s) is presented only to demonstrate an example of the invention. Additional and/or alternative embodiments of the invention will be apparent to one of ordinary skill in the art upon reading the aforementioned disclosure.

It is claimed:

1. A computer-implemented method for generating speech models for use in speech recognition of a user speech input, comprising the steps of:
determining word conceptual networks that are formed by grouping words with pre-selected pivot words, said groupings of words forming phrases directed to pre-selected concepts;
associating phoneme networks with the words in the word conceptual networks, said phoneme networks containing probabilities for recognizing the words in the word conceptual networks; and
partitioning a language model into sub-language models based upon the pivot words, said sub-language models including the phoneme networks that are associated with the words grouped with the sub-language models' respective pivot words.
